(19) United States
(12) Patent Application Publication
(10) Pub. No.: US 2017/0208031 A1
(43) Pub. Date: Jul. 20, 2017

(54) METHOD FOR MODIFYING A PORTMAP OF A CPE DEVICE, RESPECTIVE CPE DEVICE AND COMPUTER/PROGRAM

(71) Applicant: THOMSON LICENSING, Issy les Moulineaux (FR)

(72) Inventor: Carl WUYTS, Aarschot (BE)

(21) Appl. No.: 15/329,230

(22) PCT Filed: Jul. 23, 2015
(86) PCT No.: PCT/EP2015/066883

§ 371 Date: Jan. 25, 2017

(30) Foreign Application Priority Data
Jul. 25, 2014 (EP) 1430203.2

(51) Int. Cl. H04L 29/12; H04L 12/66

(52) U.S. Cl. CPC H04L 61/2053; H04L 61/2007; H04L 61/2015; H04L 12/66; H04L 61/6022

(57) ABSTRACT

A method for modifying a portmap of a CPE device comprises: when a portmap is added for a device, checking (110) in the CPE device if an IP address of the device is already present in another portmap; when the IP address of the device is not present in another portmap, then fetching (120) an IP address and/or a MAC address for the device; and adding (140) a static lease entry for the device.

### TECHNICAL FIELD

The present disclosure relates to a customer premises equipment (CPE) device, for example an access gateway, being configured to operate via a broadband connection with a network service provider network for providing Internet services.

### BACKGROUND

Access gateways are widely used to connect devices in a home or an enterprise to the Internet or to any other wide area networks (WAN). Access gateways including wireless technology have a key role in today's home and professional environments. Access gateways, in particular residential gateways for home networks, are configured to use, for example, digital subscriber line (DSL) technology that enables a high data rate transmission over copper lines or optical transmission lines for Internet services.

An access gateway is a communication device that interfaces a first network, generally a local area network (LAN), to a second network, generally an Internet Protocol (IP) based public network such as the Internet. Access to the Internet is provided by an Internet Service Provider (ISP), also called a network service provider (NSP). The ISP provides a public Internet address to the access gateway. The access gateway gets the public IP address from an ISP server located on the Internet by using a Dynamic Host Configuration Protocol (DHCP), as defined by the Internet Engineering Task Force (IETF) in a recommendation RFC (Internet Engineering Task Force-Request for Comments) 2131. The access gateway generally comprises a DHCP server that is configured to provide private IP addresses to devices in the LAN. The access gateway also comprises a Network Address Port Translation (NAPT) router compliant with the IETF recommendation RFC 3022. This enables devices of the LAN to access the Internet through the access gateway.

To enable some Internet Protocol version 4 (IPv4) services, e.g. some game services, an end-user of the LAN is required to add portmaps for it. The portmaps are included in a DHCP server lease table in the access gateway. A portmap provides a communication with a network server by linking a Media Access Control (MAC) address of a device of the LAN with the private IP address of the device. The link can be static, dynamic, or static by a manually added entry. These portmaps are needed to allow some specific unsolicited inbound traffic towards a specific device in the LAN with private IP addresses and avoid packets getting dropped in a firewall and/or by the NAPT router of the access gateway.

In order to do this, a graphical user interface (GUI) page is present in the access gateway, which allows the end-user to add and delete portmaps for different device IPs and IP ports. The problem area is the persistency. A device of the LAN is not guaranteed to receive the same IP address when re-connecting to the access gateway, so in case the device gets a new IP address from the access gateway, the portmap would have to be adjusted.

A known solution to fix this is to add devices as static leases into the lease table of the access gateway. To do this, the end-user must add a list through the GUI page, linking the MAC address of the device to a certain IPv4 address. This will ensure, no matter the presence of other devices and/or reboots of the device, that the device receives the same IPv4 address, so that changes to portmaps won't be needed.

The disadvantage here is that this is expecting from the end-user to know what leases are, MAC addresses, etc., which might not be the case for every end-user. On top, it's adding extra configuration actions for the end-user.

Another disadvantage is that the lease table might be loaded with too many entries resulting in an out-of-addresses situation, so no more devices can be connected anymore.

US 2013/0058256 A1 discloses a port mapping method comprising: obtaining a static port mapping information that includes a corresponding relationship between a public network port number, a DHCP client identifier, and a private network port number; obtaining a corresponding relationship between the DHCP client identifier and a private network IP address and a public network IP address of a NAT gateway; and establishing a port mapping relationship.

### SUMMARY

A method for modifying a portmap of a CPE device comprises: when a portmap is added for a device, checking in the CPE device if an IP address of the device is already present in another portmap; when the IP address of the device is not present in another portmap, then fetching an IP address and/or a MAC address for the device; and adding a static lease entry for the device. The static lease entry for this device is added in an embodiment in a lease table, if this device is not included already in the lease table.

In an aspect of the invention present disclosure, the method is performed by a DHCP server within the CPE device.

In another aspect of the invention present disclosure, the method comprises: when a portmap is removed for the device, checking if the IP address of this device is already present in another portmap, and if the static lease entry for this device was manually added, then do not remove it, else, remove static lease entry.

A CPE device includes a microcontroller, a memory and a DHCP server being configured to perform the method. The CPE device is in particular an access gateway or a residential gateway.

A computer readable storage medium includes instructions for performing the method.

A computer program, being executable by a processor, comprises executable program code for performing the method.

### BRIEF DESCRIPTION OF THE DRAWINGS

Exemplary embodiments of the present disclosure are explained in more detail below by way of example with reference to schematic drawings, which show:

FIG. 1 a diagram illustrating a network including an access gateway,

FIG. 2 a chart illustrating a method for modifying portmaps of a lease table included in the access gateway of FIG. 1,

FIG. 3 a flow chart illustrating a method for adding a portmap, and

FIG. 4 a flow chart illustrating a method for deleting a portmap.

It should be understood that the drawings are for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the following, a method for modifying a portmap, to be performed within a CPE device, and a CPE device being configured for performing the method are described. The CPE device is for example an access gateway, but also other devices such as routers, switches, telephones and set-top boxes are understood in this context as CPE devices. For purposes of explanation, numerous specific details are set forth in order to provide a thorough understanding of the embodiments. It will be evident, however, to one skilled in the art that the present invention may be practiced without these specific details.

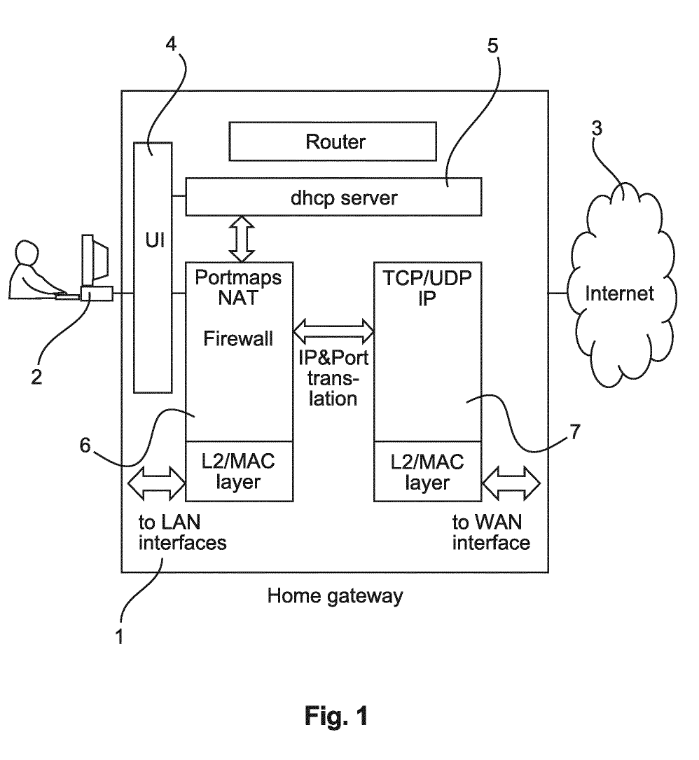

The FIG. 1 depicts a network including a CPE device 1 being adapted to perform the method for modifying a portmap. The CPE device 1 is for example an access gateway, and includes a central processing unit, a non-volatile memory in which an operating system and applications are stored, and a volatile memory for the operation of the access gateway. The access gateway may include further hardware and software components for providing for example gateway and switching functions for a home network, and may include further foreign exchange service (FXS) functions, Voice over IP (VoIP) functionality and Wi-Fi operation.

The access gateway 1 is configured as a router and connects a device 2 of an end-user, e.g. a personal computer (PC), a tablet PC or laptop, with the Internet 3. The device 2 is in particular an Internet-enabled device, for example a host device of a home network. The access gateway 1 comprises further a user interface 4, and a DHCP server 5 for allocating IP addresses. By means of the DHCP server 5, IP address and port translation is performed between a LAN side 6 and a WAN side 7 of the access gateway 1.

In a preferred embodiment, the DHCP server of the access gateway 1 includes a lease table, also known as a lease list, and performs the following program steps:

| | |
|---|---|
| IF | the end-user adds a portmap |
| THEN | check if this host IP is already present in another portmap |

| | |
|---|---|
| IF | not present in other portmaps |

THEN fetch info for this host (IP address + MAC address)

IF static lease table does not include this host yet
THEN add static lease entry
ELSE nothing to do

ELSE nothing to do

| | |
|---|---|
| IF | the end-user removes a portmap |
| THEN | check if this host IP is already present in another portmap |

| | |
|---|---|
| IF | not present in other portmaps |

THEN fetch info for this host (IP address + MAC address)

IF static lease entry was manually added
THEN do NOT remove it
ELSE remove static lease entry

ELSE nothing to do

Under portmap it is understood in this context in particular a fixed, static, assignment of a MAC address with an IP address, to allow the device 2 to communicate with the Internet, for example to play any computer game by using always the same IP address. The “host” can be any device 2, e.g. a host device within a home network.

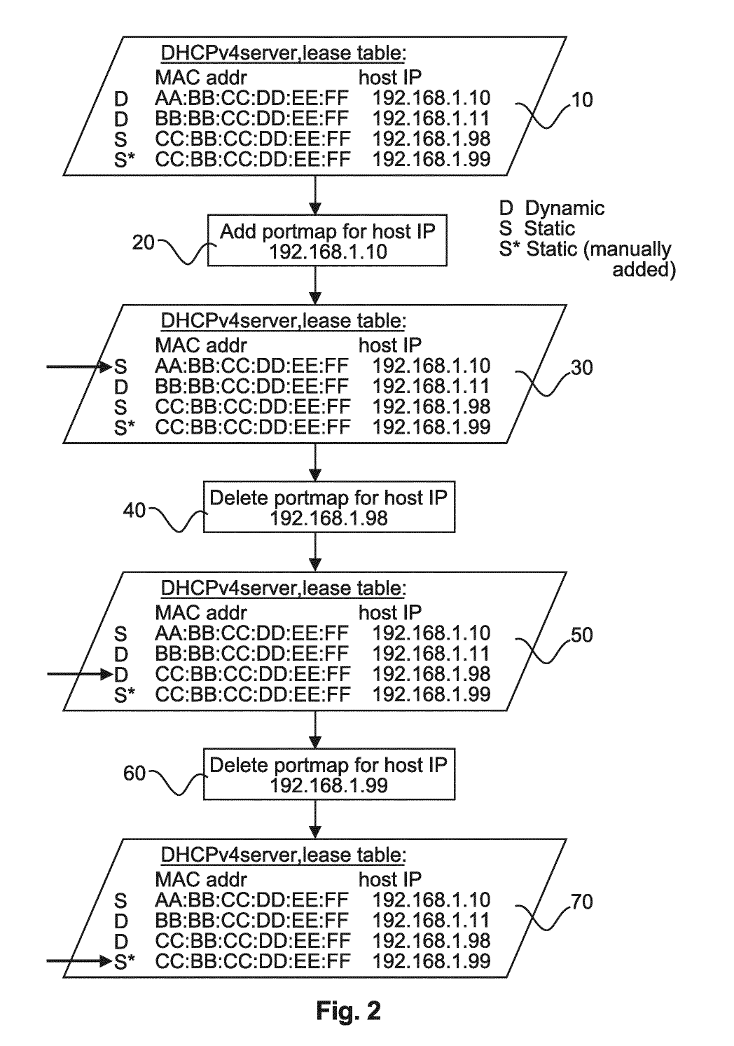

FIG. 2 describes an example for adding and deleting of a lease entry and checking of the lease table. Box 10 shows entries of a lease table of a DHCP IP version 4 server assigning a MAC address to an IP address of four host devices, including for example device 1. The allocations D, S, S* have the following meaning:

D=dynamic allocation (lease)

S=static allocation (lease)

S*=manually added static allocation (lease)

As indicated in box 10 of FIG. 2, two devices have a dynamic allocation, one device has a static allocation, through portmap adding, and one device has a manually added static allocation. In a step 20, a portmap is added for the first device, host IP: 192.168.1.10. Then the DHCP server changes the allocation for the first device from dynamic allocation D to static allocation S, box 30, as indicated by an arrow.

In another step, a portmap is deleted for the third device 192.168.1.98, indicated in box 40. Then, the DHCP server changes the allocation for the third device from static allocation S to dynamic allocation D, box 50, as indicated by an arrow.

In a further step, a request is received to delete the portmap for the fourth device 192.168.1.99, indicated in box 60. Then, the DHCP server does not change the allocation for the fourth device, because the allocation of the fourth device is a manually added static allocation S*, box 70, as indicated by an arrow.

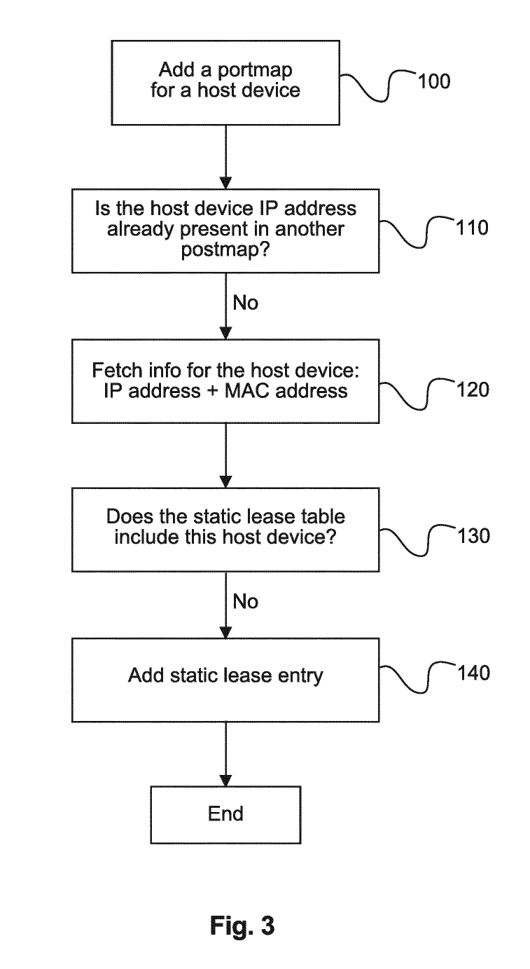

A method for adding a portmap for the CPE device 1 is illustrated in more detail in FIG. 3. If an end-user of the CPE device 1 adds a portmap for the device 2, 100, then the DCHP server of the CPE device 1 checks whether the IP address of the device 2 is already present in another portmap, 110. If this is not the case, then the DHCP server fetches the IP address and the MAC address for the device 2, 120. In a next step, the DHCP server checks whether the lease table includes already the device 2, 130. If the lease table does not include the device 2, then a static lease entry is added for the device 2, 140.

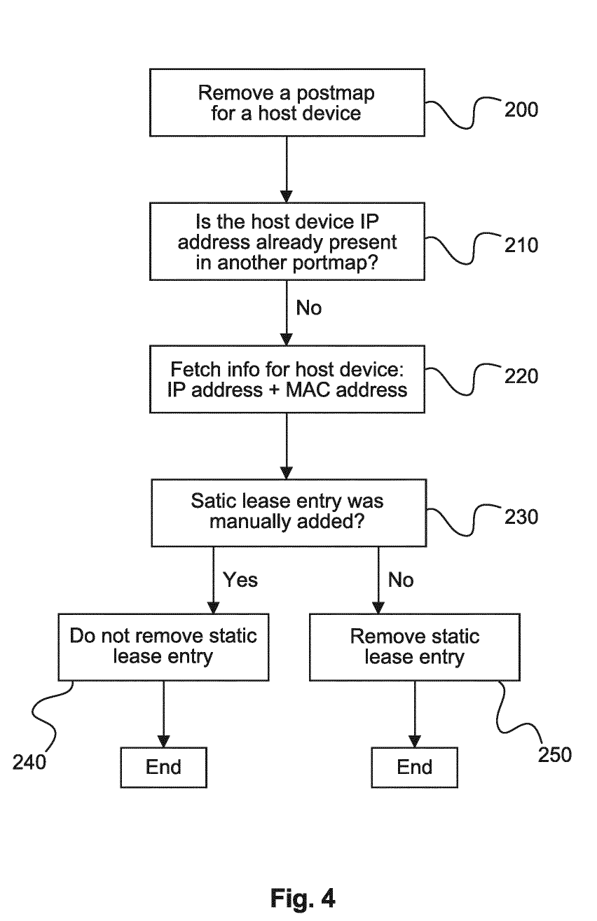

A method for removing a portmap of the CPE device 1 is illustrated in more detail in FIG. 4. If the end-user removes a portmap, 200, then the DHCP server of the CPE device 1 checks if the IP address of the device 2 is already present in another portmap, 210. In case the IP address of the device 2 is not present, then the DHCP server fetches for the device 2 the IP address and the MAC address, 220. In case the static lease entry was manually added, 230, then the static lease entry is not removed from the lease table, 240. If the static lease entry was not manually added, then the static lease entry is removed from the lease table, 250.

With a method as described with regard to FIG. 3, automatically a static lease entry is provided by the DHCP server within the CPE device 1 for a service or an application needing a portmap. The end-user does not have to check any IP address or MAC address of the device 2. The DHCP server links the MAC address of the device with an available IP address automatically, if not already done. This will ensure that, independent of the presence of other devices within the network or reboots of the device 2, that the device 2 always obtains the same IP address, so that changes to the portmap won't be needed. In addition, the method as described with regard to FIG. 4 removes only automatically added static lease entries, but not release entries being manually added by an end-user, so that only the required static lease entries are maintained in the lease table, to avoid pool depletion due to the dynamic allocation mechanism.

Although embodiments which incorporate the teachings of the present disclosure have been shown and described in detail herein, those skilled in the art can readily devise many other varied embodiments that still incorporate these teachings. Having described preferred embodiments (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure.

1. A method for modifying a portmap of a CPE device, comprising:
when a portmap is added for a device, checking in the CPE device if an IP address of this device is already present in another portmap,
when the IP address of this device is not present in another portmap, then fetching an IP address or a MAC address for this device and adding a static lease entry for the device.

2. The method of claim 1, wherein the static lease entry for this device is added in a lease table, if this device is not included already in the lease table.

3. The method of claim 1, comprising:
when a portmap is removed for the device, checking if the IP address of this device is already present in another portmap, and
if the static lease entry for this device was manually added, then do not remove it, else, remove the static lease entry.

4. The method of claim 3, comprising:
if the IP address of this device is not present in another portmap then fetch an IP address and a MAC address of this device.

5. (canceled)

6. The method of claim 1, wherein the method is performed by a DHCP server within the CPE device.

7. A CPE device including a microcontroller, a memory and a DHCP server being configured to perform a method according to claim 1.

8. The CPE device of claim 7, wherein the CPE device is an access gateway or a residential gateway.

9. A computer readable storage medium including instructions for performing a method according to claim 1.

10. A non-transitory program storage medium, readable by a processor and comprising executable program code for performing a method in accordance with claim 1.

11. A computer program, executable by a processor and comprising executable program code for performing a method in accordance with claim 1.

12. A CPE device including a microcontroller, a memory and a DHCP server, having stored instructions for modifying a portmap within the CPE device, being adapted
to check in the CPE device if an IP address of a device is already present in another portmap, when a portmap is added for the device,
to fetch an IP address or a MAC address for this device and to add a static lease entry for the device when the IP address of this device is not present in another portmap.

13. The CPE device of claim 12, wherein the DHCP server is adapted to add the static lease entry for this device in a lease table, if this device is not already included in the lease table.

14. The CPE device of claim 12, wherein the DHCP server is adapted:
to check if the IP address of this device is already present in another portmap, when a portmap is removed for the device, and
if the static lease entry for this device was manually added, then to not remove it, else, to remove the static lease entry.

15. The CPE device of claim 14, wherein the DHCP server is adapted to fetch an IP address and a MAC address of this device, if the IP address of this device is not present in another portmap.

16. (canceled)

17. The CPE device of claim 12, wherein the CPE device is an access gateway or a residential gateway.
